(19) United States
(12) Patent Application Publication
(10) Pub. No.: US 2026/0260277 A1
(43) Pub. Date: Sep. 3, 2026

(54) MULTI-AGENT ARTIFICIAL INTELLIGENCE SYSTEM FOR AUTONOMOUS TASK CLASSIFICATION AND EXECUTION

(71) Applicant: Maplebear Inc., San Francisco, CA (US)

(72) Inventors: Vinesh Reddy Gudla, South San Francisco, CA (US); Tejaswi Tenneti, San Carlos, CA (US)

(21) Appl. No.: 19/067,569

(22) Filed: Feb. 28, 2025

(51) Int. Cl. G06Q 30/0601; G06F 16/3329

(52) U.S. Cl. CPC G06Q 30/0631; G06F 16/33295; G06Q 30/0641

(57) ABSTRACT

An agentic framework for solving open ended queries, a first artificial intelligence (AI) agent prompts a first large language model (LLM) to determine tasks based in part on a query received from a user device. The tasks are provided to a second AI agent, which includes one or more LLMs. The second AI agent determines results for schemes using a process. The process includes prompting, by the second AI agent, an LLM of the LLMs to determine a scheme based in part on the tasks. The scheme describes application programming interface (API) calls that are associated with at least one of the tasks. The process includes executing the API calls of the scheme to obtain a result that includes at least one item recommendation. The process is repeated until a successful result of a scheme satisfies conditions and includes item recommendations. The item recommendations are provided to the user device.

### BACKGROUND

A large language model is conventionally trained with a very large set of public data, which may include upwards of tens of trillions of tokens. This training process injects the large language model with generic knowledge and concepts that the large language model can use to respond to questions. However, conventionally trained large language models typically lack specific domain knowledge for various types of online platforms. As such, conventionally trained large language models are generally limited in providing generic responses to queries versus responding with specific domain information about the online platform (e.g., a specific product in a catalog of a retail platform). Moreover, while artificial intelligence (AI) agents are becoming more common in e-commerce applications, AI agents are typically trained to perform specific tasks and thus are not able to address open ended queries effectively.

### SUMMARY

In accordance with one or more aspects of the disclosure, an agentic framework for solving open-ended queries is described. The agentic framework may be part of an online system. A user provides a query to a user client device (i.e., user client), where the query may be an open-ended query. The online system receives the query from the user client. The agentic framework of the online system includes an artificial intelligence (AI) agent. In some embodiments, the agentic framework includes a first AI agent and a second AI agent. The online system may prompt (e.g., by the AI agent or the first AI agent) a first large language model (LLM) to determine one or more tasks based in part on the query. The first LLM may be part of an AI system that is separate from the online system, the online system, or part of both the AI system and the AI system.

The one or more tasks are provided to an AI agent. In some embodiments, with a first AI agent and a second AI agent, the AI agent may be the second AI agent. The AI agent includes one or more LLMs. The AI agent may determine one or more results for one or more schemes using a process. The process may include the AI agent prompting a LLM of the one or more LLMs to determine a scheme based in part on the one or more tasks. A scheme may describe one or more actions (e.g., application programming interface (API) calls) that are associated with at least one of the one or more tasks. The process may also include executing the one or more actions (e.g., API calls) of the scheme to obtain a result that includes at least one item recommendation. The process may be repeated until a successful result of a scheme of the one or more schemes satisfies one or more conditions and the successful result includes one or more item recommendations. The one or more item recommendations may be provided to the user device.

The first LLM may be a general generative LLM having world knowledge (but lacking specific domain knowledge of the online system) and is able to effectively break down queries (including open ended queries) into one or more tasks to perform to resolve the query. In contrast, the one or more LLMs of the AI agent have specific domain knowledge of the online system, but are not as efficient (relative to the first LLM) in breaking down open ended queries into tasks. The first LLM may be tuned using, e.g., a plurality of training queries and corresponding training tasks. And the training tasks may include tasks that may be performed by the one or more LLMs of the AI agent. In this manner, the agentic framework is able to use the first LLM to efficiently break down an open ended query into tasks that may be executed by the one or more LLMs of the AI agent. The AI agent may then use the tasks and the process in an iterative manner to determine a scheme of using the one or more LLMs that satisfies one or more conditions. In this manner, the online system is able to use the world knowledge and reasoning abilities of generative models and the reliability and expertise of domain specific LLMs (of the AI agent) for performing tasks (e.g., scoring, ranking, etc.) to determine personalized item recommendations in response to queries (in particular open ended queries).

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3 is an example block diagram showing operation of an agentic framework of an online system, in accordance with some embodiments.

FIG. 4 is an example sequence diagram that describes using an agentic framework of an online system to respond to queries with domain specific answers, in accordance with some embodiments.

FIG. 5 is a flowchart for a method of using an agentic framework to solve open ended queries, in accordance with some embodiments.

### DETAILED DESCRIPTION

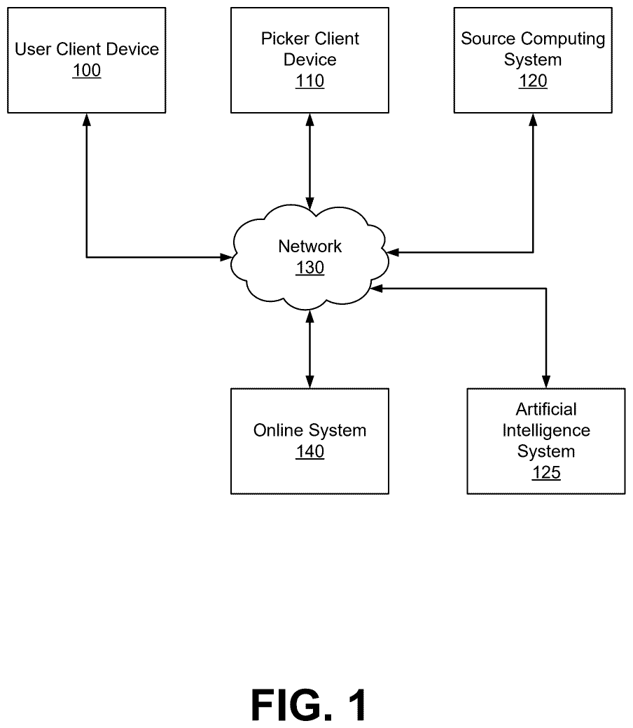

FIG. 1 illustrates an example system environment for an online system 140, in accordance with one or more embodiments. The system environment illustrated in FIG. 1 includes a user client device 100, a picker client device 110, a source computing system 120, an artificial intelligence (AI) system 125, a network 130, and an online system 140. Alternative embodiments may include more, fewer, or different components from those illustrated in FIG. 1, and the functionality of each component may be divided between the components differently from the description below. For example, some or all of the functionality of the AI system 125 may be performed by the online system 140. Additionally, each component may perform their respective functionalities in response to a request from a human, or automatically without human intervention.

Although one user client device 100, picker client device 110, AI system 125, and source computing system 120 are illustrated in FIG. 1, any number of users, pickers, AI systems, and sources may interact with the online system 140. As such, there may be more than one user client device 100, picker client device 110, AI system 125, or source computing system 120.

The user client device 100 is a client device through which a user may interact with the picker client device 110, the source computing system 120, or the online system 140. The user client device 100 may be referred to as a “user device.” The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The user client device 100 may receive a query from the user. The query may be open ended. An open ended query has a plurality of different answers. For example, an open ended query may be “Recommend a breakfast for under $20,” “What is a good gift for Valentine's Day,” etc. The user client device 100 may receive the query from the user via, e.g., the ordering interface. The user client device 100 provides the query to the online system 140. The user client device 100 receives a response to the query from the online system 140. The response includes one or more recommendations for items that are associated with one or more items that satisfy the query. Each recommendation for an item includes item information (e.g., item name, item identifier, etc.) associated with the item. The user client device 100 presents (e.g., via the ordering interface) the one or more recommendations of items to the user.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The AI system 125 may be configured to apply prompts to one or more large language models (LLMs) to generate responses to the prompts. The AI system 125 includes one or more LLMs. The one or more LLMs may be generative machine-learning models having world knowledge.

The one or more LLMs of the AI system 125 may be tuned using information from the online system 140. For example, a first LLM of the AI system 125 may be tuned with training queries and corresponding training tasks from the online system 140. The one or more training tasks correspond to tasks that one or more LLMs of the online system 140 are able to perform. In this manner, a first LLM of the AI system 125 can be tuned to break down received queries into one or more tasks that can be performed by LLMs of the online system 140.

In some embodiments, the tuning process for a LLM involves specialized fine-tuning using a structured dataset of query-task pairs specific to the online system domain. The dataset comprises thousands of example queries that users might reasonably make to the online system, each paired with a structured decomposition of appropriate executable tasks that the second AI agent can perform. The tuning process may employ a multi-stage approach that begins with supervised fine-tuning where the model is trained to map input queries to their corresponding task decompositions while preserving the model's general reasoning capabilities. Fine-tuning uses a combination of task-specific parameters and hyperparameter optimization to ensure the model performs effectively within the agentic framework. The training process includes both positive examples (queries with their correct task decompositions) and negative examples (queries with inappropriate task breakdowns) to help the model establish appropriate boundaries. Additionally, the fine-tuning process incorporates domain-specific context windows that provide the first LLM with sufficient context about the capabilities of the second AI agent, ensuring that the tasks it generates are executable by the second agent's available tools and APIs. In other embodiments, the LLM is tuned, in addition or alternatively, by prompt-tuning, wherein information for further training the LLM in a particular domain is included in the body of the prompt.

The AI system 125 may determine one or more tasks based in part on prompts received from the online system 140. The AI system 125 may receive a prompt from the online system 140 to generate one or more tasks based in part on queries received from the user client device 100. The AI system 125 provides the generated set of one or more tasks to the online system 140.

The user client device 100, the picker client device 110, the source computing system 120, the AI system 125, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 may receive a query (e.g., “What is a good Valentine's Day gift?”) for a recommendation for an item from a user client device 100. The online system 140 includes an agentic framework that may include a first AI agent and a second AI agent. In some embodiments, the functions of the first AI agent and the second AI agent may be performed by a single AI agent.

An AI agent (e.g., the first AI agent) of the online system generates a prompt based in part on the query, and prompts a first LLM (e.g., of the AI system 125) to break down the query into one or more tasks that can be performed by LLMs of the online system 140.

In some embodiments, the tasks output from the first LLM may be provided to the second AI agent. The second AI agent determines a response to the query based in part on tasks. The second AI agent includes one or more LLMs. A scheme may be a plan that describes one or more actions (e.g., API calls) that are associated with one or more tasks. In some embodiments, the scheme also describes an order in which the one or more actions (e.g., API calls) are to be performed. The second AI agent may determine one or more results for one or more schemes using a process. The process may include, e.g., prompting, by the second AI agent, a LLM to determine a scheme based in part on the tasks received from the first AI agent. The second AI agent executes the actions of the scheme to obtain a result that includes item recommendations. In some embodiments, the result is a page that includes the item recommendations. The second AI agent evaluates (e.g., using an LLM) the result to determine whether or not the result satisfies one or more conditions (e.g., constraints associated with the query (e.g., the item recommendation is appropriate for Valentine's Day), sufficient engagement score, etc.). The second AI agent may determine that the result of the process does not satisfy the one or more conditions for one or more reasons, and generate feedback based on the one or more reasons. And for a subsequent iteration of the process, the second AI agent may prompt the LLM to determine a new scheme based in part on the one or more tasks and the feedback. In this manner, the second AI agent repeats the process until it outputs a result (having one or more item recommendations) that successfully satisfies the one or more conditions. The online system 140 may provide the one or more item recommendations to the user client device 100.

The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

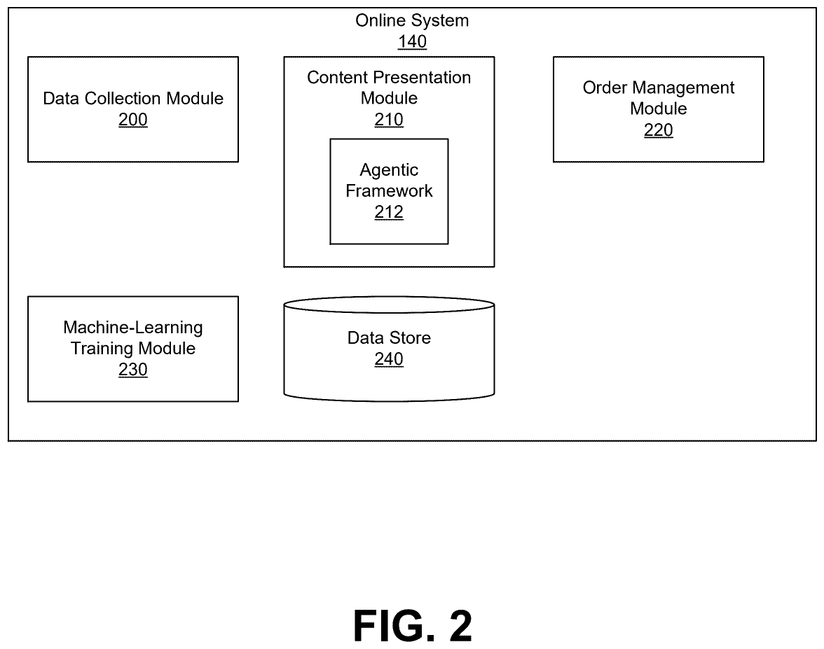

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order.

The content presentation module 210 processes queries for item recommendations from user client devices using an agentic framework 212. The agentic framework 212 may include a first AI agent and a second AI agent. In some embodiments, instead of a first AI agent and a second AI agent, the agentic framework 212 includes a single AI agent or more than two AI agents that perform the functions of the first AI agent and the second AI agent. The first AI agent may be configured to use a first LLM to determine tasks that should be performed in order to satisfy the queries. The determined tasks are tasks that can be performed via the second AI agent. As described below, the first LLM may be tuned (by the machine-learning training module 230) to break down queries into one or more tasks that can be performed by the second AI agent. The one or more tasks may include, e.g., retrieving previous data associated with the user, retrieving item information about items, scoring and ranking the retrieved items, selecting items from the ranked items in accordance with one or more constraints derived from the query, etc. For example, if the query was to “Provide items to make a breakfast for under $20,” the one or more tasks may include constraints like, e.g., (1) items are for breakfast, and (2) having a total cost of under $20. In some embodiments, the first AI agent includes the first LLM. In some embodiments, some or all of the first LLM is part of the AI system 125, and the first AI agent is configured to interact with at least a portion of the first LLM through the AI system 125. The first AI agent may generate prompts based in part on received queries, and prompts the first LLM to determine tasks based in part on the queries. The first AI agent provides the tasks output from the first LLM to the second AI agent.

The second AI agent is configured to determine responses to the queries based in part on the tasks output from the first LLM. The second AI agent includes one or more LLMs. In some embodiments, the one or more LLMs are actually small-language models that are trained using data from the online system 140 to have domain knowledge specific to the online system 140. The one or more LLMs may be used to perform different functions. Functions may include, e.g., developing a scheme based in part on one or more tasks (and in some cases feedback), performing various actions (e.g., API calls) to execute a scheme, evaluating results of schemes, etc. The various actions may be part of various tools used by the second AI agent to perform a task. The tools may include, e.g., a retrieval tool configured to retrieve data (e.g., user data, order data, etc.) associated a user of the user client device making the query, a retrieval tool configured to retrieve item data about one or more items of the online catalog, a ranking tool to rank items (e.g., to score (e.g., by engagement score) and rank items), a recommendation tool for recommending items that supplement items recommended in response to the query, a basket tool configured to compile a basket of items, etc. In some embodiments, the tools used by the second AI agent may differ from those described above.

The second AI agent uses a process in an iterative manner to determine a successful result to respond to a query. For a given set of one or more tasks associated with a query, the second AI agent applies the set of one or more tasks, and in some cases feedback on a result of a previous scheme, to the process to determine a new result. The process may include, e.g., prompting, by the second AI agent, a LLM of the one or more LLMs to determine a scheme based in part on the one or more tasks received from the first AI agent. A scheme may be a plan to generate, using some or all of the tasks output from the first LLM, a response to the query. A scheme describes one or more actions (e.g., API calls) that are associated with one or more tasks output from the first LLM. In some embodiments, the scheme also describes an order in which the one or more actions are to be performed. In some embodiments, the scheme may prescribe that the one or more actions be performed in a serial manner.

The second AI agent executes the actions of the scheme to obtain a result that includes one or more item recommendations that may satisfy the query. For example, the second AI agent may make the one or more API calls in accordance with the scheme to obtain the result. In some embodiments, the result is a page that includes the one or more item recommendations.

The second AI agent evaluates the result to determine whether or not the result satisfies one or more conditions. The second AI agent may evaluate the result using an LLM of the one or more LLMs. The second AI agent may, e.g., prompt the LLM to determine whether the result satisfies the one or more conditions. The one or more conditions are requirements that are met in order for a result to be considered successful. The one or more conditions may include, e.g., satisfying some or all of the constraints associated with the query, item recommendations associated with the result have a sufficient engagement score, etc.

In some embodiments, the second AI agent may determine that the result of the process does not satisfy the one or more conditions for one or more reasons. Continuing with the example above, the one or more item recommendations may have a total cost that exceeds $20, thereby violating the constraint of having a total cost of under $20. The second AI agent generates feedback based in part on the one or more reasons. For example, the second AI agent may generate feedback indicating that the total cost is too expensive. And for the subsequent iteration of the process, the second AI agent may prompt the LLM to determine a new scheme based in part on the one or more tasks and the feedback. And the feedback may cause the LLM to generate a scheme that uses less costly items (e.g., may use substitute items, look at other brands, etc.). In this manner, the second AI agent may repeat the process to obtain new schemes and corresponding results, until an iteration of the process outputs a result (having one or more item recommendations) that successfully satisfies the one or more conditions. In response to the query from the user client device, the content presentation module 210 may provide the one or more item recommendations associated with the successful result to the user client device. In this manner, the online system 140 is able to use world knowledge and reasoning abilities of the first LLM and the reliability and expertise of domain specific LLMs of the second AI agent to determine personalized item recommendations in response to queries (in particular open ended queries).

In one or more embodiments, the one or more conditions that determine a successful result comprise a hierarchical, multi-dimensional evaluation framework. At a primary level, result may satisfy all hard constraints explicitly or implicitly derived from the query, such as budget limitations, categorical requirements, or temporal constraints. In one example, if a query specifies “items under $20,” the total cost of recommended items must not exceed this threshold. These primary conditions are non-negotiable and serve as filtering criteria. At a secondary level, the evaluation framework may assess the result's quality across multiple dimensions including: (1) relevance score, which measures how well the recommendations align with the user's query intent; (2) personalization score, which evaluates how well the recommendations reflect the user's historical preferences and previous orders; (3) diversity score, which ensures the recommendations provide sufficient variety within the constrained parameters; and (4) novelty score, which balances familiar items with appropriate new discoveries. These quality dimensions may be combined using a weighted utility function that produces a composite engagement score. The weights in this utility function may be personalized to individual users based on their interaction patterns.

In some embodiments, for a result to be considered successful, it must both satisfy all primary constraints and achieve a composite engagement score above a dynamically determined threshold. This threshold is not static but adjusts based on the complexity of the query, the user's history, and the number of iterations the system has already performed. In cases where multiple results satisfy all conditions, the system may select the result with the highest composite engagement score, breaking ties by prioritizing results that offer the most balanced performance across all quality dimensions. This comprehensive evaluation framework allows the system to optimize for both accuracy and user satisfaction.

The content presentation module 210 also may identify items that the user is most likely to order and present item recommendations for those items to the user. In some embodiments, this is in accordance with an API call performed by an LLM of the agentic framework 212. For example, the content presentation module 210 may score items and rank the items based on their scores in accordance with an API call performed by an LLM of the second AI agent. The content presentation module 210 displays item recommendations for the items with scores that exceed some threshold (e.g., the top n items or the p percentile of items).

The content presentation module 210 may use an item selection model to score items for presentation to a user. In some embodiments, this is in accordance with an API call performed by an LLM of the second AI agent. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. In some embodiments, this is in accordance with an API call performed by an LLM of the second AI agent. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. In some embodiments, this is in accordance with an API call performed by an LLM of the second AI agent. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out item recommendations for items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models (e.g., LLMs) used by the online system 140. For example, the machine-learning training module 230 may train the one or more LLMs of the second AI agent, and in some embodiments, may also train the first LLM (e.g., of the AI system 125). The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The first LLM may be a general generative LLM that lacks specific domain knowledge of the online system 140. The machine-learning training module 230 may tune the first LLM (e.g., of the AI system 125) using information from the online system 140. For example, machine-learning training module 230 may tune the first LLM using training queries and corresponding training tasks. The one or more training tasks correspond to tasks that the one or more LLMs of the second AI agent are able to perform. In this manner, the first LLM can be tuned to break down received queries into one or more tasks that can be performed by the one or more LLMs of the second AI agent. In this manner, the agentic framework is able to use the first LLM to efficiently break down an open ended query into tasks that may be executed by the one or more LLMs of the AI agent.

The data store 240 stores data used by the online system 140. For example, the data store 240 stores user data, item data, order data, and picker data for use by the online system 140. The data store 240 may also store, e.g., queries, tasks, schemes, results, some other data used by the online system 140 to develop responses to queries from user client devices, or some combination thereof. The data store 240 also stores trained machine-learning models (e.g., the one or more LLMs of the second AI agent, and in some cases the first LLM) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

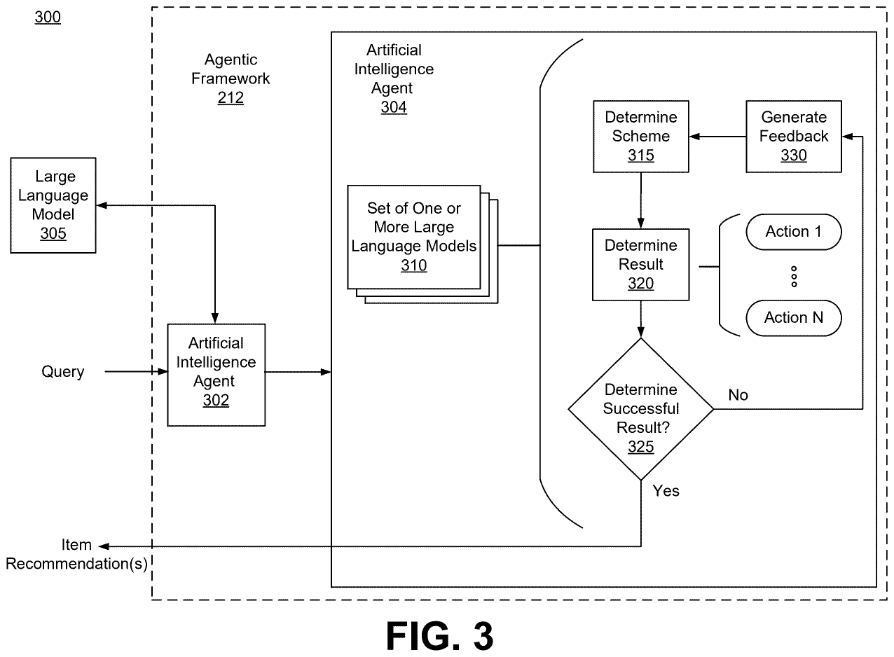

FIG. 3 is an example block diagram 300 showing operation of the agentic framework 212 of the online system 140, in accordance with some embodiments. In the illustrated embodiment, the agentic framework 212 includes an AI agent 302 and an AI agent 304. In other embodiments, the AI agent 302 and the AI agent 304 may be replaced with a single AI agent (e.g., that performs the functions of the AI agent 302 and the AI agent 304) or three or more AI agents. Alternative embodiments may include more, fewer, or different components from those illustrated in FIG. 3, and the functionality of each component may be divided between one or more of the components.

The agentic framework 212 receives a query. The query is associated with a user of a user client device (e.g., the user client device 100). The query may be an open-ended query. For example, the query may be “Build a weekly shopping list of the user for under $100.”

The AI agent 302 uses a LLM 305 to determine tasks that should be performed in order to satisfy the query. The LLM 305 may be part of an AI system (e.g., the AI system 125), may be part of the AI agent 302, or may be part of both the AI system and the AI agent 302. The AI agent 302 may generate a prompt for the LLM 305 based in part on the query. The AI agent 302 may provide the LLM 305 with the generated prompt. Responsive to the prompt, the LLM 305 outputs tasks that are provided to the AI agent 302. The tasks provide a high level guidance in how to develop a response to the query using tools that may be available to the AI agent 304. For example, the tasks may include, e.g., retrieving previous order data associated with the user, retrieving item information for various items, scoring and ranking items, and selecting items from the ranked items in accordance with one or more constraints derived from the query (e.g., total cost under $100, item recommendations are for a weekly shopping list), etc. The AI agent 302 provides the tasks to the AI agent 304.

The AI agent 304 uses a process in an iterative manner to determine a successful result for responding to the query. The AI agent 304 includes a set of one or more LLMs 310 which it uses for generating schemes, executing actions (e.g., API calls) to execute various tasks in accordance with generated schemes, evaluate results of schemes, etc. As part of the process, the AI agent 304 determines 315 a scheme based on the tasks. For example, the AI agent 304 may prompt a LLM of the set of one or more LLMs 310 to determine a scheme based in part on tasks received from the AI agent 302. The AI agent 304 determines 320 a result of the scheme. For example, the AI agent 304 using one or more LLMs of the set of one or more LLMs 310 may perform N actions (e.g., API calls) described by the scheme to determine the result, where N is a positive integer. The result includes one or more item recommendations that may satisfy one or more conditions. In some embodiments, the result is a page that includes the one or more item recommendations.

The AI agent 304 determines 325 using a LLM of the set of one or more LLMs 310 whether or not the result is successful. A successful result satisfies one or more conditions. The AI agent 304 may evaluate the result using a LLM of the one or more LLMs. The AI agent 304 may, e.g., prompt the LLM to determine whether the result satisfies the one or more conditions (e.g., satisfying some or all of the constraints in the query, item recommendations associated with the result have a sufficient engagement score, etc.).

In embodiments where the result is not successful, the AI agent 304 generates 330 feedback. The generated feedback is based on one or more reasons why the result did not satisfy the one or more conditions (e.g., total cost exceeded $100 dollars, engagement score is too low, etc.). The AI agent 304 may then start a new iteration of the process, where the scheme is determined 315 based in part on the tasks and the feedback. In this manner, the process repeats until the AI agent 304 determines 325 that a result having one or more item recommendations is successful. The agentic framework 212 may then output the one or more item recommendations associated with the successful result. The one or more item recommendations may then be provided to the user client device in response to the query.

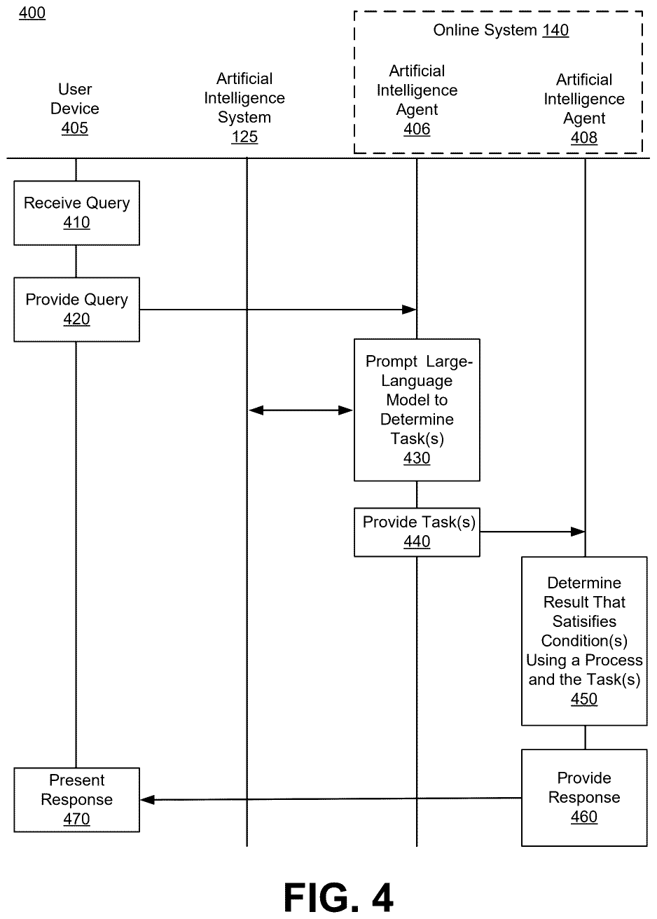

FIG. 4 is an example sequence diagram 400 that describes using an agentic framework of the online system 140 to respond to queries with domain specific answers, in accordance with some embodiments. Alternative embodiments may include more, fewer, or different interactions from those illustrated in FIG. 4, and the steps may be performed in a different order from that illustrated in FIG. 4. The sequence diagram 400 describes some actions of a user device 405, the AI system 125, and an AI agent 406 and an AI agent 408 of an agentic framework of the online system 140. The user device 405 is an embodiment of the user client device 100, the AI agent 406 is an embodiment of the first AI agent described above with regard to FIG. 1, FIG. 2, or the AI agent 302 of FIG. 3, and the AI agent 408 is an embodiment of the second AI agent described above with regard to FIG. 1, FIG. 2, or the AI agent 304 of FIG. 3. Alternative embodiments may include more, fewer, or different components from those illustrated in FIG. 4, and the functionality of each component may be divided between the components differently from the description below. For example, in some embodiments, the AI agent 406 and the AI agent 408 are replaced with a single AI agent that is configured to have the functionality of both the AI agent 406 and the AI agent 408.

The user device 405 receives 410 a query from a user of the user device 405. The query may query a recommendation for one or more items. In some embodiments, the query may be open ended. The user device 405 may receive the query via an ordering interface. The user device 405 provides 420 the query to the online system 140.

The AI agent 406 prompts 430 a LLM of the AI system 125 to determine one or more tasks based in part on the query. The LLM may be a general generative LLM having world knowledge (but lacking specific domain knowledge of the online system 140) and is able to effectively break down queries (including open ended queries) into one or more tasks to perform to resolve the query. The LLM outputs one or more tasks that are provided to the AI agent 406. In some embodiments, some or all of the functionality of the AI system 125 is performed by the online system 140. For example, the LLM may be part of the AI agent 406. The AI agent 406 provides 440 the one or more tasks to the AI agent 408.

The AI agent 408 determines 450 a result that satisfies one or more conditions using a process and the one or more tasks. The AI agent 408 uses the process in an iterative manner to determine a result that satisfies one or more conditions. As part of the process, the AI agent 408 determines a scheme based on the tasks received from the AI agent 406. The AI agent 408 then uses one or more LLMs to perform actions (e.g., API calls) detailed in the scheme to obtain a result. The result includes at least one item recommendation. The AI agent 408 evaluates the result using an LLM of the one or more LLMs to determine whether the result satisfies one or more conditions. If the one or more conditions are not satisfied, the AI agent 408 generates feedback based on reasons why the one or more conditions were not satisfied. The AI agent 408 may then start a new iteration of the process, where a new scheme is determined based in part on the tasks and the feedback. The process repeats until the AI agent 408 determines that a result having one or more item recommendations successfully satisfies the one or more conditions. The online system 140 provides 460 a response based on the successful result to the user device 405. For example, the response may be the one or more item recommendations or a page including the one or more item recommendations.

The user device 405 presents 470 the response to the user. In some embodiments, the user device 405 presents the response via the ordering interface of the user device 405.

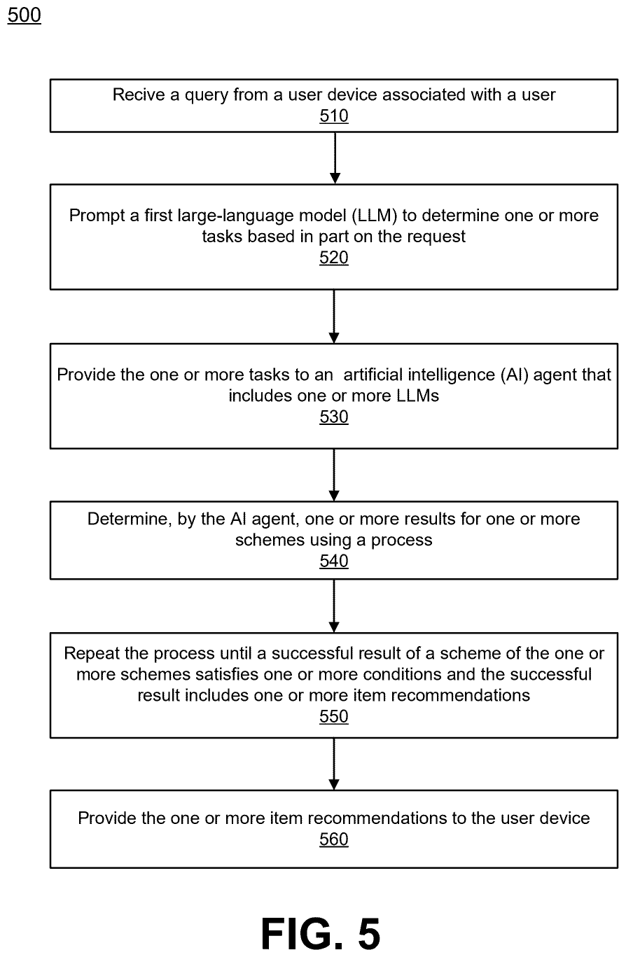

FIG. 5 is a flowchart for a method of using an agentic framework to solve open ended queries, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system receives 510 a query from a user device associated with a user. The query may be, e.g., an open ended query. The user device may be, e.g., the user client device 100.

The online system prompts 520 a first LLM to determine one or more tasks based in part on the query. For example, a first AI agent of an agentic framework of the online system 140 may generate the prompt based in part on the query. The first AI agent may prompt the first LLM using the generated prompt. The first LLM may be part of an AI system (e.g., the AI system 125), the first AI agent, or both the AI system and the first AI agent. Responsive to the prompt, the first LLM outputs one or more tasks. The tasks output by the first LLM may also include constraints to be satisfied in order to successfully respond to the query. For example, the first LLM may be used to identify constraints associated with the query, and generate one or more tasks based in part on the identified constraints. For example, if the query was to “Recommend items to make an Italian dinner for 4, for under $50,” the LLM may determine that the query includes a constraint that the items are to be for an Italian dinner, a constraint that a meal made using the items includes at least 4 servings, and a constraint that a total cost of the items be less than $50. The online system may generate a task that the identified constraints are to be satisfied as a condition of providing item recommendations to the user device in addition to one or more tasks (e.g., retrieving previous data associated with the user, retrieving item information about items, scoring and ranking the retrieved items, selecting items from the ranked items in accordance with one or more constraints derived from the query, etc.) for the online system to perform to determine a response to the query.

The online system provides 530 the one or more tasks to an AI agent that includes one or more LLMs. For example, the first AI agent may provide the one or more tasks to the AI agent (e.g., a second AI agent).

The online system determines 540, by the AI agent, one or more results for one or more schemes using a process. The process is applied in an iterative manner to determine a result that satisfies one or more conditions. The AI agent (e.g., the second AI agent) prompts a LLM of the one or more LLMs to determine a scheme based in part on the one or more tasks. The scheme may describe one or more actions (e.g., API calls) that are associated with at least one of the one or more tasks. The one or more API calls of the scheme are executed (e.g., via one or more LLMs of the one or more LLMs) to obtain a result that includes at least one item recommendation. In some embodiments, the one or more API calls are executed in series in accordance with an order described in the scheme.

The online system repeats 550 the process until a successful result of a scheme of the one or more schemes satisfies one or more conditions and the successful result includes one or more item recommendations. The one or more conditions may include, e.g., satisfying the one or more constraints, having a sufficient engagement score, etc. In some embodiments, the AI agent may determine an engagement score for the one or more item recommendations of the result based in part on user data and order data that are associated with the user. The AI agent may determine that a condition is satisfied if the engagement score is above a threshold value. In some embodiments, the AI agent may determine that a condition is satisfied if the result has a highest engagement score relative to previous results. For example, the AI agent may determine engagement scores for each of a plurality of results of a plurality of schemes. The AI agent may rank the plurality of results by the engagement scores, and select a successful result from the plurality of results based on the ranking.

The online system provides 560 the one or more item recommendations to the user device. In some embodiments, the successful result is a page that includes the one or more item recommendations. The online system may provide the page to the user device, and the user device presents the page.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving a query from a user device associated with a user;
prompting a first large language model (LLM) to generate one or more tasks based in part on the query;
providing the one or more tasks to an artificial intelligence (AI) agent that includes one or more LLMs;
generating, by the AI agent, one or more results for one or more schemes using a process, the process comprising:
prompting, by the AI agent, a LLM of the one or more LLMs to generate a scheme based in part on the one or more tasks, wherein the scheme describes one or more application programming interface (API) calls that are associated with at least one of the one or more tasks,
executing the one or more API calls of the scheme to obtain a result that includes at least one item recommendation, and
determining whether the result satisfies one or more conditions;
repeating the process until the result satisfies one or more conditions and includes one or more item recommendations;
in response to the result satisfying one or more conditions and including one or more item recommendations, identifying the result as a successful result; and
providing the one or more item recommendations to the user device, causing the user device to display the one or more recommendations.

2. The method of claim 1, wherein the one or more conditions include satisfying one or more constraints associated with the query, the method further comprising:
identifying the one or more constraints associated with the query; and
determining that the successful result satisfies the one or more constraints.

3. The method of claim 2, wherein the one or more conditions further include an engagement score over a threshold value, and wherein repeating the process until the successful result of the scheme of the one or more schemes satisfies the one or more conditions and the successful result includes the one or more item recommendations comprises:
generating an engagement score for the one or more item recommendations of the successful result based in part on user data and order data that are associated with the user; and
determining that the engagement score is above a threshold value.

4. The method of claim 2, wherein the one or more conditions further include a successful result have a highest engagement score relative to engagement scores of other results, and wherein repeating the process until the successful result of the scheme of the one or more schemes satisfies the one or more conditions and the successful result includes the one or more item recommendations comprises:
generating engagement scores for each of a plurality of results of a plurality of schemes;
ranking the plurality of results by the engagement scores; and
selecting a successful result from the plurality of results based on the ranking.

5. The method of claim 1, wherein the successful result is a page that includes the one or more item recommendations, and wherein providing the one or more item recommendations to the user device further comprises:
providing the page to the user device, wherein the user device presents the page.

6. The method of claim 1, comprising:
tuning the first LLM with a plurality of training queries and corresponding training tasks, wherein the training tasks include the one or more tasks, and each of the training tasks are associated with at least one of the one or more LLMs.

7. The method of claim 1, wherein executing the API calls of the scheme to obtain the result that includes the at least one item recommendation comprises:
executing the API calls in series in accordance with an order described in the scheme.

8. The method of claim 1, wherein repeating the process until the successful result of the scheme of the one or more schemes satisfies the one or more conditions and the successful result includes the one or more item recommendations further comprises:
determining that a result of the process does not satisfy the one or more conditions for one or more reasons;
generating feedback based on the one or more reasons; and
for a subsequent iteration of the process, prompting, by the AI agent, the LLM to generate a new scheme based in part on the one or more tasks and the feedback.

9. A computer program product comprising a non-transitory computer readable storage medium having instructions encoded thereon that, when executed by a processor of a computer system, cause the computer system to perform steps comprising:
receiving a query from a user device associated with a user;
prompting a first large language model (LLM) to generate one or more tasks based in part on the query;
providing the one or more tasks to an artificial intelligence (AI) agent that includes one or more LLMs;
generating, by the AI agent, one or more results for one or more schemes using a process, the process comprising:
prompting, by the AI agent, a LLM of the one or more LLMs to generate a scheme based in part on the one or more tasks, wherein the scheme describes one or more application programming interface (API) calls that are associated with at least one of the one or more tasks,
executing the one or more API calls of the scheme to obtain a result that includes at least one item recommendation, and
determining whether the result satisfies one or more conditions;
repeating the process until the result satisfies one or more conditions and includes one or more item recommendations;
in response to the result satisfying one or more conditions and including one or more item recommendations, identifying the result as a successful result; and
providing the one or more item recommendations to the user device, causing the user device to display the one or more recommendations.

10. The computer program product of claim 9, wherein the one or more conditions include satisfying one or more constraints associated with the query, and the computer program product further comprises encoded instructions that when executed cause the computer system to perform steps comprising:
identifying the one or more constraints associated with the query; and
determining that the successful result satisfies the one or more constraints.

11. The computer program product of claim 10, wherein the one or more conditions further include an engagement score over a threshold value, and wherein the encoded instructions for repeating the process until the successful result of the scheme of the one or more schemes satisfies the one or more conditions and the successful result includes the one or more item recommendations cause the computer system to perform steps comprising:
generating an engagement score for the one or more item recommendations of the successful result based in part on user data and order data that are associated with the user; and
determining that the engagement score is above a threshold value.

12. The computer program product of claim 10, wherein the one or more conditions further include a successful result having a highest engagement score relative to engagement scores of other results, and wherein the encoded instructions for repeating the process until the successful result of the scheme of the one or more schemes satisfies the one or more conditions and the successful result includes the one or more item recommendations cause the computer system to perform steps comprising:
generating engagement scores for each of a plurality of results of a plurality of schemes;
ranking the plurality of results by the engagement scores; and
selecting a successful result from the plurality of results based on the ranking.

13. The computer program product of claim 9, wherein the successful result is a page that includes the one or more item recommendations, and wherein the encoded instructions for providing the one or more item recommendations to the user device cause the computer system to perform steps comprising:
providing the page to the user device, wherein the user device presents the page.

14. The computer program product of claim 9, further comprising encoded instructions that when executed cause the computer system to perform steps comprising:
tuning the first LLM with a plurality of training queries and corresponding training tasks, wherein the training tasks include the one or more tasks, and each of the training tasks are associated with at least one of the one or more LLMs.

15. The computer program product of claim 9, wherein executing the API calls of the scheme to obtain the result that includes the at least one item recommendation cause the computer system to perform steps comprising:
executing the API calls in series in accordance with an order described in the scheme.

16. The computer program product of claim 9, wherein the encoded instructions for repeating the process until the successful result of the scheme of the one or more schemes satisfies the one or more conditions and the successful result includes the one or more item recommendations cause the computer system to perform steps comprising:
determining that a result of the process does not satisfy the one or more conditions, for one or more reasons;
generating feedback based on the one or more reasons; and
for a subsequent iteration of the process, prompting, by the AI agent, the LLM to generate a new scheme based in part on the one or more tasks and the feedback.

17. A computer system comprising:
a processor; and
a non-transitory computer readable storage medium having instructions encoded thereon that, when executed by the processor, cause the computer system to perform steps comprising:
receiving a query from a user device associated with a user;
prompting a first large language model (LLM) to generate one or more tasks based in part on the query;
providing the one or more tasks to an artificial intelligence (AI) agent that includes one or more LLMs;
generating, by the AI agent, one or more results for one or more schemes using a process, the process comprising:
prompting, by the AI agent, a LLM of the one or more LLMs to generate a scheme based in part on the one or more tasks, wherein the scheme describes one or more application programming interface (API) calls that are associated with at least one of the one or more tasks,
executing the one or more API calls of the scheme to obtain a result that includes at least one item recommendation, and
determining whether the result satisfies one or more conditions;
repeating the process until the result satisfies one or more conditions and includes one or more item recommendations;
in response to the result satisfying one or more conditions and including one or more item recommendations, identifying the result as a successful result; and
providing the one or more item recommendations to the user device, causing the user device to display the one or more recommendations.

18. The computer system of claim 17, wherein the one or more conditions further include an engagement score over a threshold value, and wherein the encoded instructions for repeating the process until the successful result of the scheme of the one or more schemes satisfies the one or more conditions and the successful result includes the one or more item recommendations cause the computer system to perform steps comprising:
generating an engagement score for the one or more item recommendations of the successful result based in part on user data and order data that are associated with the user; and
determining that the engagement score is above a threshold value.

19. The computer system of claim 17, wherein the one or more conditions further includes a successful result have a highest engagement score relative to engagement scores of other results, and wherein the encoded instructions for repeating the process until the successful result of the scheme of the one or more schemes satisfies the one or more conditions and the successful result includes the one or more item recommendations cause the computer system to perform steps comprising:
generating engagement scores for each of a plurality of results of a plurality of schemes;
ranking the plurality of results by the engagement scores; and
selecting a successful result from the plurality of results based on the ranking.

20. The computer system of claim 17, further comprising encoded instructions that when executed cause the computer system to perform steps comprising:
tuning the first LLM with a plurality of training queries and corresponding training tasks, wherein the training tasks include the one or more tasks, and each of the training tasks are associated with at least one of the one or more LLMs.
